(19) United States
(12) Patent Application Publication
(10) Pub. No.: US 2017/0080551 A1
(43) Pub. Date: Mar. 23, 2017

(54) FASTENING DEVICE FOR A WRENCH

(71) Applicant: Chin-Ying Chou, Taichung City (TW)

(72) Inventor: Chin-Ying Chou, Taichung City (TW)

(21) Appl. No.: 14/859,363

(22) Filed: Sep. 21, 2015

(51) Int. Cl. B25B 13/46; B25B 23/00

(52) U.S. Cl. CPC B25B 13/463; B25B 23/0035

(57) ABSTRACT

A fastening device for a wrench is disclosed. The wrench body has a handle portion and a driving portion. A detenting assembly has a ratchet ring and a detenting teeth block. A covering hole is passing through a center of the ratchet ring. An allocating member is installed in the driving portion and has a turning plate and a controlling post. An elastic sleeving member is arranged between the controlling post and the detenting teeth block. The barrel or tool bit is quickly separated from the covering hole while the barrel or tool bit is pivoted to correspond to a concave arc hole by the allocating member. And he barrel or tool bit is firmly fastened in the covering hole to prevent from being separated in operation while the barrel or tool bit is not corresponding to the concave arc hole

### BACKGROUND OF THE INVENTION

1. Field of the Invention

The present invention relates to a fastening device for a wrench, and especially relates to a fastening device capable for firmly fastening the barrel or the tool bit to the wrench and preventing the barrel or the tool bit from being separated or dropping while in operation.

2. Description of Related Art

The wench is one of the indispensable tools since the home appliances, home decorations, and even large scale industries depend on the wrench to screw in or out to assemble or disassemble. Therefore, the wrench is one of the most important tools for a user or repairman. There are many kinds of wrenches, such as box wrenches, ratchet wrenches, and T-wrenches. Each kind of the wrenches corresponds to its own screws with different sizes and shapes. With the evolution of the times, in order to light the weight of the carried tools which include the wrench and be easy to insert into the small space of the screw to operate, the wrench is modified by many inventors to add various kinds of the barrels or tool bits for meeting the use of different screws. Therefore, besides the screws with different sizes and shapes may be assembled or disassembled by the wrench directly, they may be also assembled or disassembled by the wrench through installing the barrel or tool bit. The above descriptions are pointing out the relationship between the wrench and the barrel or the tool bit, Actually, the key point is that the assembly and the position between the wrench and the barrel or the tool bit.

Please reference to Taiwanese patent no. M426472, which is disclosed “a clip apparatus device for a wrench”. The wrench mainly comprises a wrench body having an accommodating portion arranged at at least one end thereof, a ratchet ring base arranged at the accommodating portion of the wrench body, a ratchet device arranged between the ratchet ring base and the wrench body, and at least one clip device arranged on the ratchet ring base. The outer ring wolf teeth are arranged on an outer ring surface of the ratchet ring base. A connection portion is dodecagon and formed at an inner ring surface of the ratchet ring base. The clip device has an elastic clip assembly which is arranged at neighboring wall between two adjacent inner corners of the connection portion so that the clip assembly may be protruded from a connection surfaces of the two adjacent inner corners simultaneously. When the exterior hexagonal objects is covered by the interior dodecagonal connection portion of the ratchet ring base, the objects may be firmly clipped by the clip assembly to improve the efficiency. Although the barrel may be firmly fastened at the wrench through the clip device, the elastic member is against the ball to block the barrel and easy to become elastic fatigue after operating for a long time. And then, the barrel is hard to smoothly be pushed out from the wrench.

Please reference to Taiwanese patent no. M466758, which is disclosed “a screwdriver-bit wrench tool”. The wrench body has a tool base. A first end of the tool base arranged a sleeving groove with a clipping and positioning structure for connecting the positioning tool bit. A second end of the tool base is fluidly communicated with the first end thereof A protruding member is arranged at the second end of the tool base of the wrench body. A pushing portion is arranged at a first end of the protruding member for passing through the sleeving groove of the tool base. A pressing portion is arranged at a second end of the protruding member for pressing and pushing the screwdriver bit. An elastic member is arranged at the second end of the tool base for pushing the protruding member to reset. The screwdriver bit may be separated from the sleeving groove by pressing and pushing the screwdriver bit and protruded more distances so as to make the screwdriver bit easy to be separated. It is convenient and easy to operate. Although the screwdriver bit is easy to be separated, the clip member provided for fastening the screwdriver bit is easy to become elastic fatigue due to the repeat of the assembly and disassembly of the screwdriver bit. Finally, the screwdriver bit may not smoothly fastened in the sleeving groove.

Please reference to Taiwanese patent no. M476030, which is disclosed “a penetrating type wrench”. The wrench has a wrench body. A front end of the wrench body has a head portion. A ratchet is arranged at the head portion. A polygonal connection hole is passing through the ratchet for connecting a barrel. A first neck portion is formed at an upper end of the ratchet. A ring groove is formed at an outer wall of the first neck portion. A plurality of through holes is formed in the ring groove of the ratchet. A C-shaped locking ring is locked in the ring groove. The through holes are provided for the C-shaped locking ring to protrude to form a limiting portion. The limiting portion may elastically stop the barrel. When a user is operating, the connection hole of the ratchet is limited the barrel to shift and move. It is that same as the screwdriver-bit wrench tool of TWM46758. The C-shaped locking ring is used for fastening the barrel, but the C-shaped locking ring easy to become elastic fatigue to result in being unable to firmly limit the barrel.

The common disadvantage as above mentioned skills is that the barrel or the screwdriver bit may not be firmly fastened at the wrench for providing operation due to the elastic fatigue of the fastening members and may be easy to be separated or drop to lose.

In view of the foregoing circumstances, the inventor has invested a lot of time to study the relevant knowledge, compare the pros and cons, research and develop related products. After quite many experiments and tests, the “fastening device for a wrench” of this invention is eventually launched to improve the foregoing shortcomings, to meet the public use.

### SUMMARY OF THE INVENTION

An object of this invention is providing a fastening device for a wrench. The barrel or the tool bit may be firmly fastened at the wrench to prevent from dropping while the barrel or the tool bit is installed in the wrench. The elastic fatigue of the members for fastening the barrel or the tool bit after operating for a long time may be improved. And the complicated structure for assembling the wrench may be also improved.

In order to achieve above mentioned effects, a fastening device for a wrench which is used for fastening a barrel or a tool bit is provided. The fastening device may comprise a wrench body, having a handle portion and a driving portion, the driving portion is connected with one end of the handle portion, an accommodating groove is arranged in the driving portion, a through hole is passing through a bottom surface of the accommodating groove, an entry slot is concavely arranged at one side wall of the accommodating groove corresponding to the handle portion, and the entry slot is fluidly communicated with the accommodating groove; a detenting assembly, having a ratchet ring and a detenting teeth block, the ratchet ring is installed in the accommodating groove of the driving portion, a plurality of teeth is arranged at a peripheral of the ratchet ring, a covering hole is formed at a center of the ratchet ring, the detenting teeth block is installed in the entry slot, a teeth bar is arranged at one side of the detenting teeth block corresponding to the teeth of the ratchet ring and the teeth bar and the detenting teeth block are engaged with each other, a pushing portion is arranged at one end of the detenting teeth block opposite to teeth bar; and an allocating member, inserted into the driving portion and corresponding to the entry slot, the allocating member includes a turning plate and a controlling post, one end of the turning plate is protruded out from the through hole and has a concave arc hole, one end of the controlling post is connected to the turning plate, the other end of the controlling post opposite to the turning plate is inserted into the entry slot, an elastic sleeving member is arranged between the controlling post and the detenting teeth block, and one end of the elastic sleeving member is against the controlling post and the other end thereof is against the pushing portion of the detenting teeth block; wherein the barrel or the tool bit is quickly separated from the covering hole due to the pivot of the allocating member while the barrel or the tool bit is corresponding to the concave arc hole, and the barrel or the tool bit is firmly fastened in the covering hole to prevent from being separated in operation while the barrel or the tool bit is not corresponding to the concave arc hole..

In some embodiments, a sharp end is formed at a top end of each side of the concave arc hole of the turning plate, and each sharp end is engaged with the tool bit or the barrel due to the pivot of the turning plate.

In some embodiments, the elastic sleeving member further includes an elastic member and a reversing block, two ends of the elastic member are respectively against the controlling post and the reversing block, one end of the reversing block opposite to the elastic member is against one end of the detenting teeth block opposite to the teeth bar, and the turning plate is stirred to control a rotating direction of the ratchet ring by the engagement of each sharp end and the tool bit or the barrel.

In some embodiments, a limiting ring groove is concavely arranged at a wall surface of the accommodating groove of the driving portion adjacent to the through hole, and a C-shaped locking ring is elastically locked in the limiting ring groove so as to limit the ratchet ring.

In some embodiments, a cap is covered on an opening of the accommodating groove, and the cap is used to limit the separation of the ratchet ring and the detenting assembly.

In some embodiments, two arc grooves are concavely arranged at the pushing portion and adjacent to each other.

The structure for engaging with the barrel or the tool bit may be omitted due to the allocating member for engaging with the barrel or the tool bit. The disassembly and assembly of the barrel or the tool bit may be avoided so as to improve the elastic fatigue of the elastic member which is arranged inside the wrench. The barrel or the tool bit may be more firmly fastened to installed in the covering hole and prevent from being separated or dropping while in operation. The user or repairman may replace the hand tools by himself based on the field situation.

The various objectives and advantages of the present invention will be more readily understood from the following detailed description when read in conjunction with the appended drawing.

### BRIEF DESCRIPTION OF THE DRAWINGS

FIG. 1 is a perspective view of a fastening device for a wrench of the present invention;

FIG. 2 is an exploded view of the fastening device of the present invention;

FIG. 3 is a top view of the fastening device of the present invention;

FIG. 4 is a cross-sectional view of FIG. 3 along the line IV-IV;

FIG. 5 is a top view of the shackle of the fastening device of the present invention while the allocating member is pivoted but not engaged with the tool bit;

FIG. 6 is a cross-sectional view of FIG. 5 along the line VI-VI;

FIG. 7 is a perspective view of the fastening device of the present invention while fastening a barrel; and

FIG. 8 is a cross-sectional view of the fastening device of the present invention after fastening the barrel.

### DETAILED DESCRIPTION OF THE INVENTION

To describe clearly that the present invention achieves the foregoing objective and function, the technical features and desired function are described with reference to a preferred embodiment and accompanying drawings.

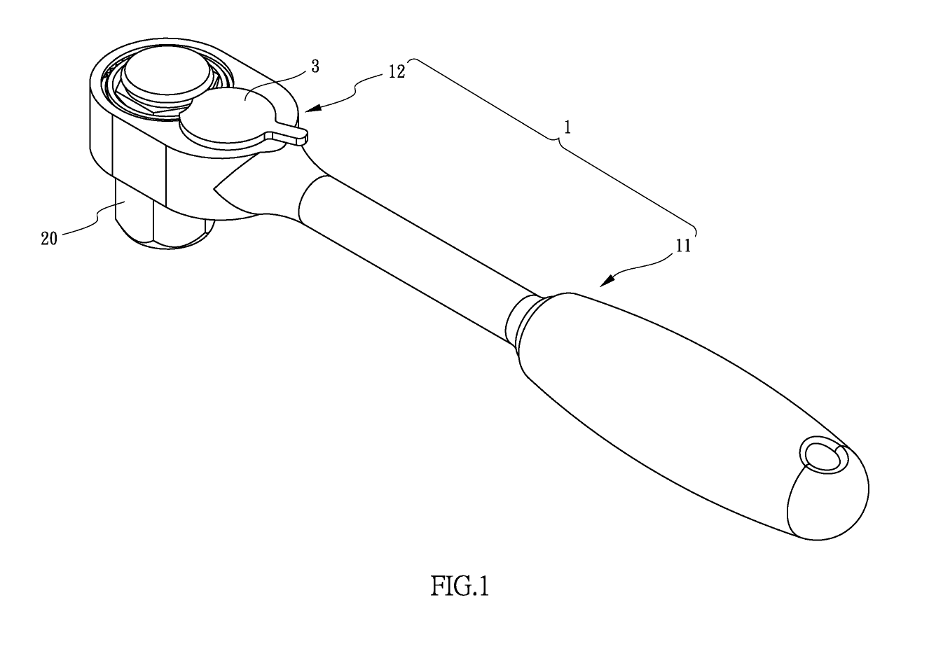

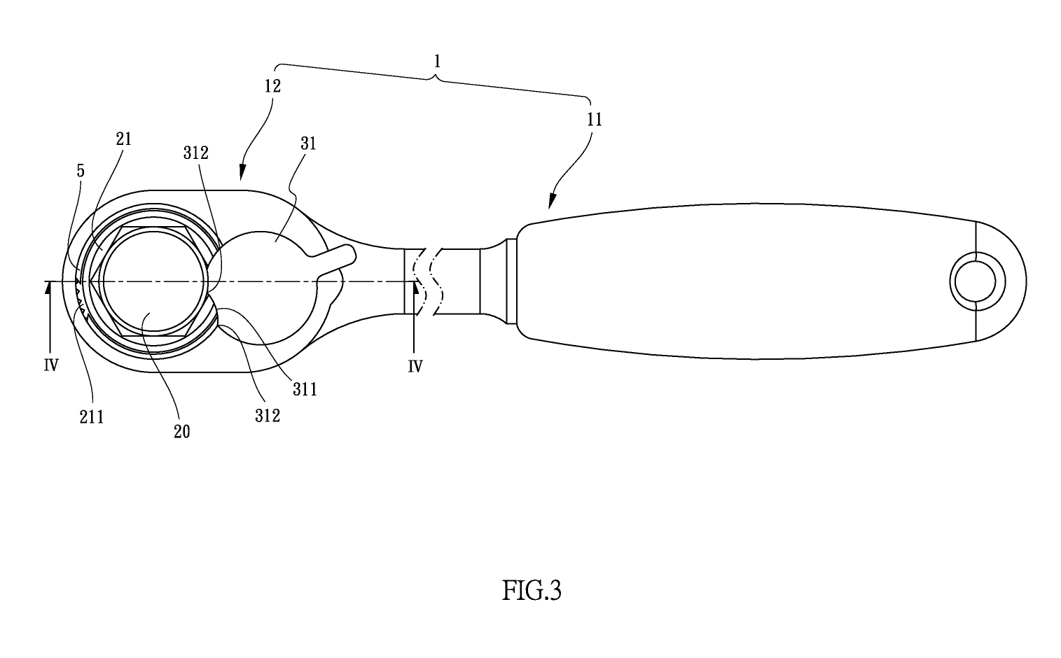

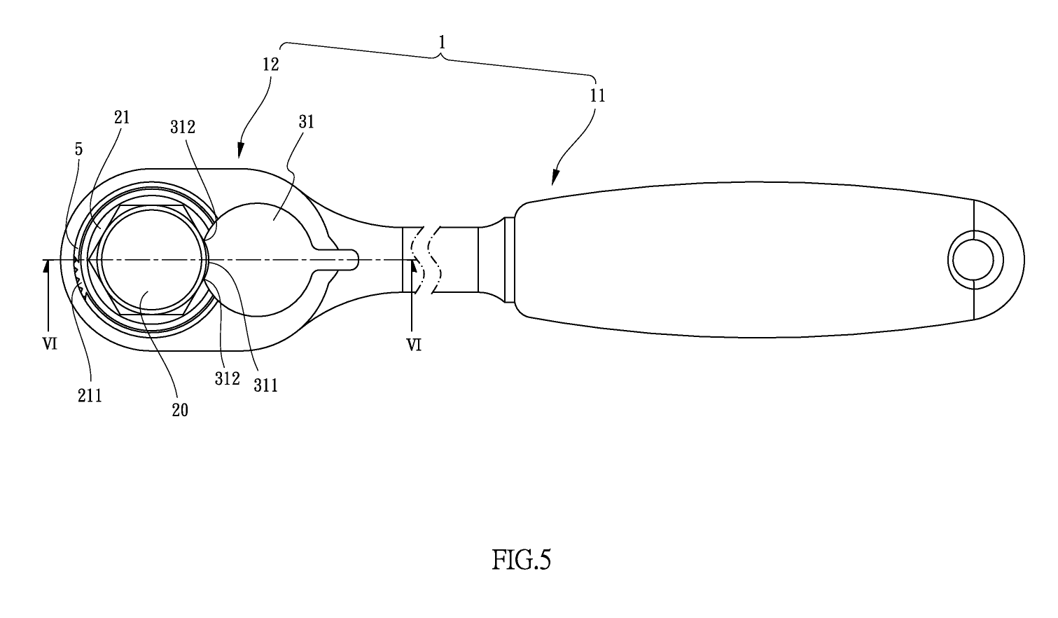

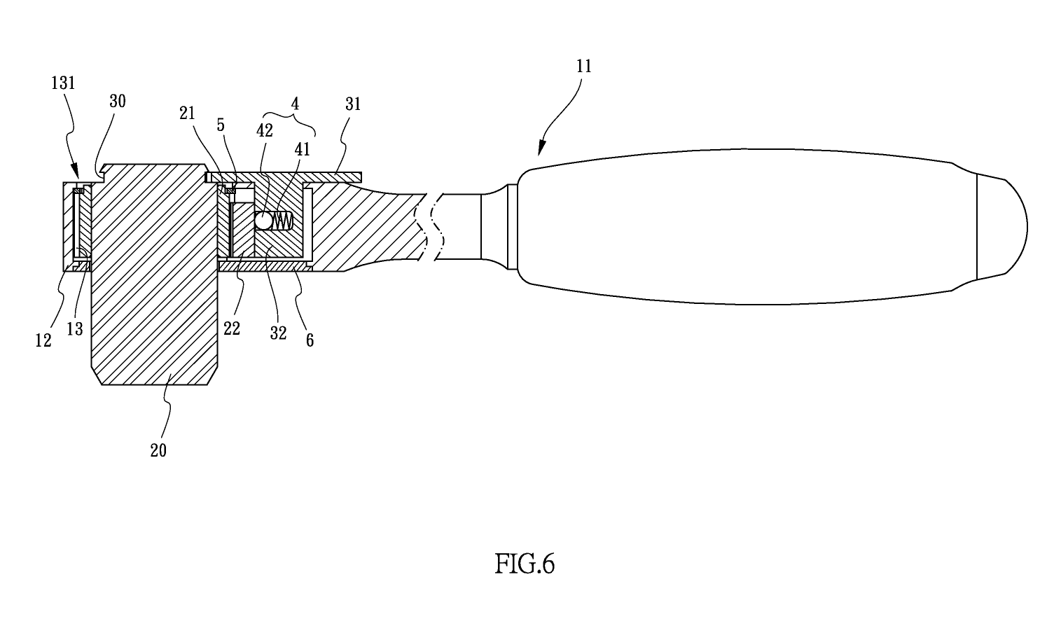

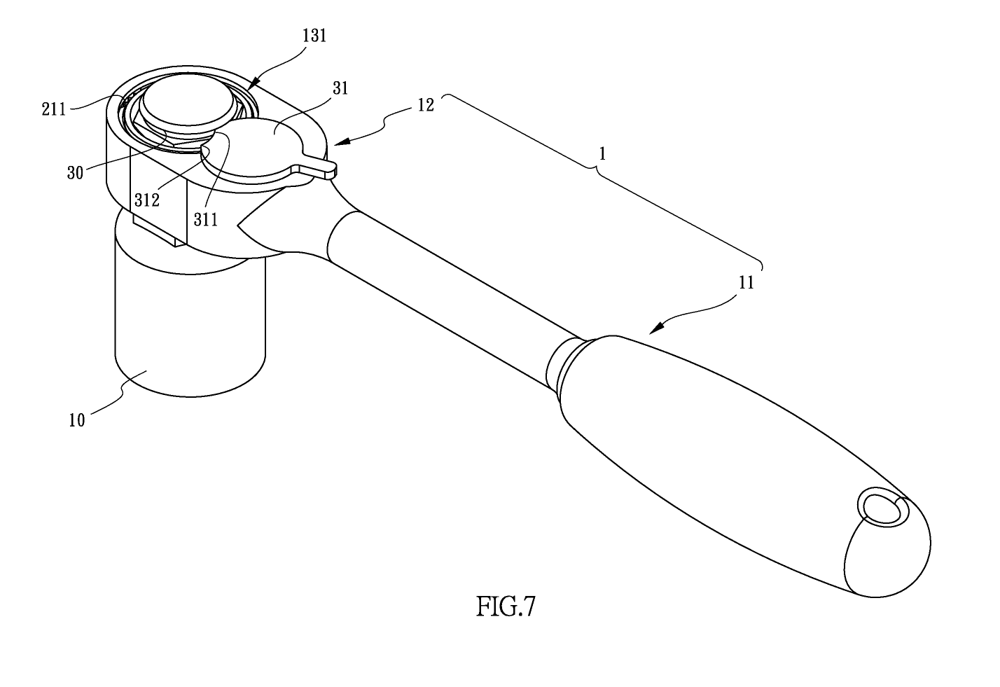

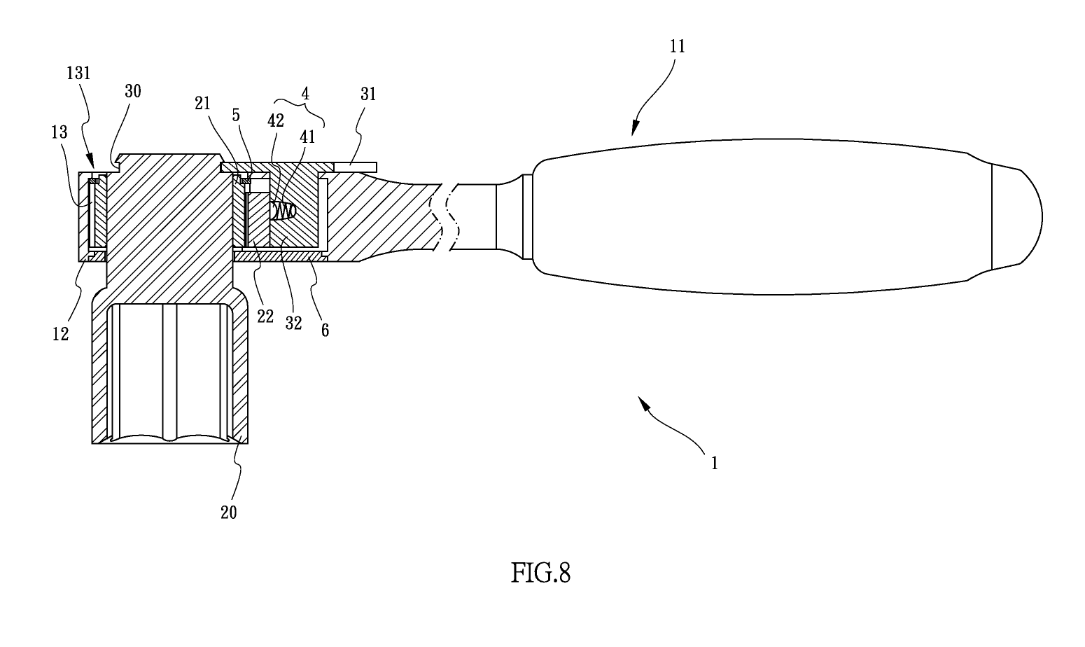

Please reference to FIGS. 1 to 6, a fastening device for a wrench of the present invention may be used for fastening a barrel 10 or a tool bit 20 (FIGS. 1 to 6 are mainly illustrated with the tool bit 20, and FIGS. 7 and 8 are mainly illustrated with the barrel 10). The conventional barrel 10 or tool bit 20 has an embedded groove which is installed at a peripheral of the barrel 10 or the tool bit 20 for engagement, but the detail descriptions are omitted. The fastening device may comprise a wrench body 1, a detenting assembly 2, and an allocating member 3. The wrench body 1 has a handle portion 11 and a driving portion 12. The driving portion 12 is connected with one end of the handle portion 11. An accommodating groove 13 is arranged in the driving portion 12. A through hole 131 is passing through a bottom surface of the accommodating groove 13. An entry slot 14 is concavely arranged at one side wall of the accommodating groove 13 which corresponds to the handle portion 11. The entry slot 14 is fluidly communicated with the accommodating groove 13. The detenting assembly 2 has a ratchet ring 21 and a detenting teeth block 22. The ratchet ring 21 is arranged in the accommodating groove 13 of the driving portion 12. A plurality of teeth 211 is arranged at a peripheral of the ratchet ring 21. A covering hole 212 is formed at a center of the ratchet ring 21. The detenting teeth block 22 is installed in the entry slot 14. A teeth bar 221 is arranged at one side of the detenting teeth block 22 which corresponds to the teeth 211 of the ratchet ring 21. The teeth bar 221 and the detenting teeth block 22 are engaged with each other. A pushing portion 222 is arranged at one end of the detenting teeth block 22 which is opposite to teeth bar 221. The allocating member 3 is inserted into the driving portion 12 and corresponding to the entry slot 14. The allocating member 3 includes a turning plate 31 and a controlling post 32. One end of the turning plate 31 is protruded out from the through hole 131 and has a concave arc hole 311. One end of the controlling post 32 is connected to the turning plate 31. The other end of the controlling post 32 which is opposite to the turning plate 31 is inserted into the entry slot 14. An elastic sleeving member 4 is arranged between the controlling post 32 and the detenting teeth block 22. One end of the elastic sleeving member 4 is against the controlling post 32 and the other end thereof is against the pushing portion 222 of the detenting teeth block 22. The barrel 10 or the tool bit 20 is quickly separated from the covering hole 212 due to the pivot of the allocating member 3 while the barrel 10 or the tool bit 20 is corresponding to the concave arc hole 311. On the contrary, the barrel 10 or the tool bit 20 is firmly fastened in the covering hole 212 to prevent from being separated in operation while the barrel 10 or the tool bit 20 is not corresponding to the concave arc hole 311.

The above mentioned embodiment is the main skill feature of this invention and corresponds to the claim 1 of this invention to understand the objective and embodiments of this invention in detail. And the skill features of the depending claims are for describing the claim 1 in detail or adding more skill features, but not limited thereto. It should be known that the claim 1 is not necessary to include the skill features of the depending claims.

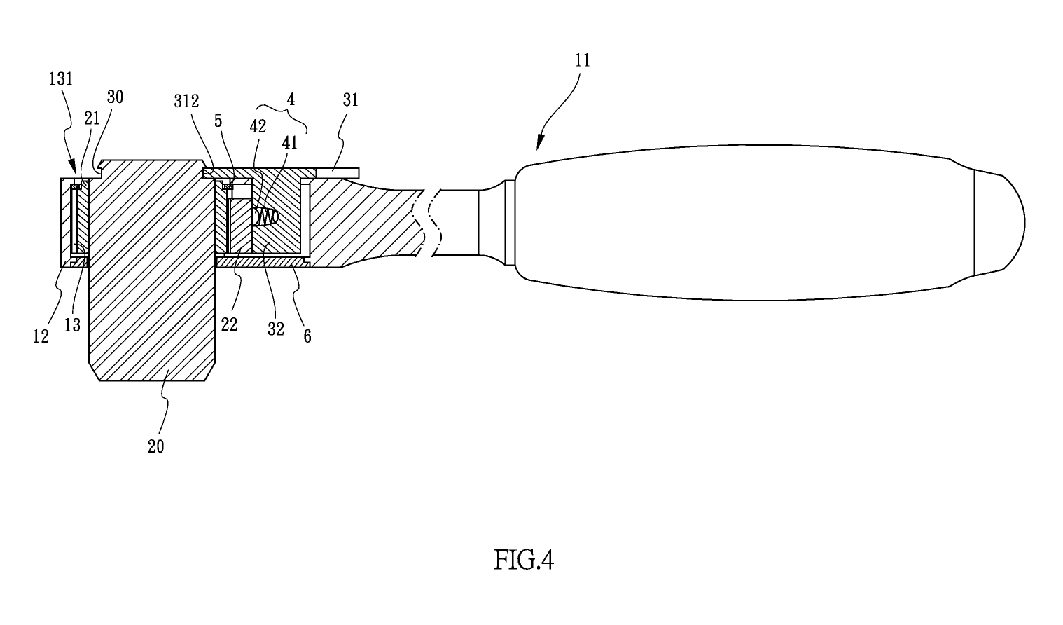

In addition, a sharp end 312 is formed at a top end of each side of the concave arc hole 311 of the turning plate 31. Each sharp end 312 is engaged with the tool bit 20 or the barrel 10 due to the pivot of the turning plate 31. After a user or a repairman is finishing the selection of the tool bit 20 or the barrel 10, the tool bit 20 or the barrel 10 is inserted into the covering hole 212 of the ratchet ring 21. The stirring direction of the turning plate 31 decides the operation direction of the ratchet ring 21 and one of the sharp ends 312 is engaged with the embedded groove of the barrel 10 or the tool bit 20 due to the design of the turning plate 31 of the allocating member 3. Therefore, the barrel 10 or the tool bit 20 is firmly fastened. Preferably, a ring groove 30 is concavely formed at a peripheral and adjacent to an edge of the barrel 10 or the tool bit 20. The ring groove 30 may be engaged with the sharp ends 312 of the turning plate 31 of the allocating member 3. Besides the arrangement of the barrel 10 or the tool bit 20 may not be influenced, the length of the barrel 10 or the tool bit 20 which is protruded may be shortened. The drawings are illustrated with the ring groove 30 of the barrel 10 or the tool bit 20 for the preferable embodiments. Due to the engagement of the ring groove 30 of the barrel 10 or the tool bit 20 and the sharp ends 312 of the turning plate 31, it is not only firmly fastened to prevent the barrel 10 or the tool bit 20 from being separated due to elastic fatigue while in operation, but also the cost is sharply decreased and the assembly becomes easier due to the simplified structure of the wrench body 1 (shown as in FIGS. 4, 6, and 8).

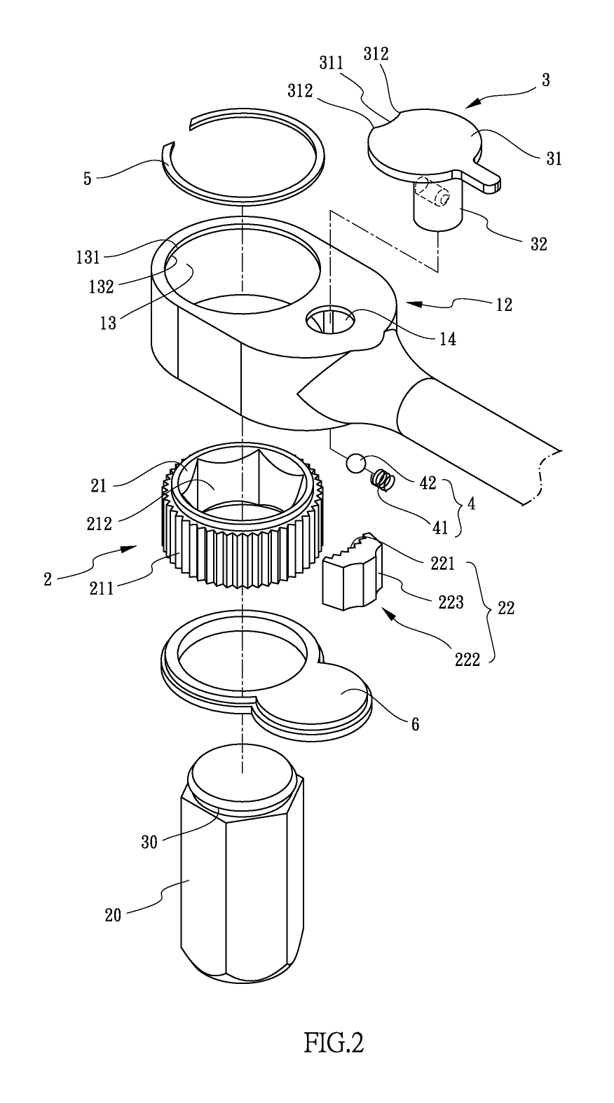

Besides the main function of the allocating member 3 is that the barrel 10 or the tool bit 20 is firmly fastened at the covering hole 21 of the ratchet ring 21, changing and controlling the rotating direction of the ratchet ring 21 is the most important. Therefore, it is especially important that an elastic sleeving member 4 is arranged between the controlling post 32 and the detenting teeth block 22. The elastic sleeving member 4 further includes an elastic member 41 and a reversing block 42. Two ends of the elastic member 41 are respectively against the controlling post 32 and the reversing block 42. One end of the reversing block 42 which is opposite to the elastic member 41 is against one end of the detenting teeth block 22 which is opposite to the teeth bar 221. Two arc grooves 223 are further concavely arranged at the pushing portion 22 and adjacent to each other. Besides the turning plate 31 may be stirred to engaged with the ring groove 30 of the barrel 10 or the tool bit 20, the turning plate 31 may be stirred to control a rotating direction of the ratchet ring 21 by the engagement of each sharp end 312 and the tool bit 20 or the barrel 10. That is, the turning plate 31 controls the pivot of the controlling post 32 and then the controlling post 32 drives the elastic member 41 and the reversing block 42 to shift. The reversing block 42 may be limited in one of the two arc grooves 223 of the detenting teeth block 22 based on the stirring direction of the turning plate 31. The engaging direction of the detenting teeth block 22 and the ratchet ring 21 may be changed based on the engagement of the reversing block 42. It may provide the user or the repairman to screw in or out of the screws (shown as in FIGS. 2, 4, 6, and 8).

In order to prevent from the ratchet ring 21 separating from the detenting teeth block 22 while the user or the repairman is operating, a limiting ring groove 132 is further concavely arranged at a wall surface of the accommodating groove 13 of the driving portion 12 which is adjacent to the through hole 131 and a C-shaped locking ring 5 is further elastically locked in the limiting ring groove 132. Part of the C-shaped locking ring 5 is engaged in the limiting ring groove 132, and the other part thereof is against the ratchet ring 21 so that the ratchet ring 21 may be limited to separate from the through hole 131 (shown as in FIGS. 2 and 4). Besides the ratchet ring 21 is limited by the C-shaped locking ring 5, a cap 6 is further covered on an opening of the accommodating groove 13. And the cap 6 is used to limit the separation of the ratchet ring 21 and the detenting assembly 22. That is, the cap 6 may close the opening of the accommodating groove 13 to prevent the ratchet ring 21 from separating from the detenting teeth block 22 and the elastic sleeving member 4 (shown as in FIG. 2).

Furthermore, the shape of the covering hole 212 of the ratchet ring 21 may be designed according to the shape of the barrel 10 or the tool bit 20. The shape of the covering hole 212 may be polygonal so that the barrel 10 or the tool bit 20 may be driven to rotate while the barrel 10 or the tool bit 20 is inserted into the covering hole 212 and the ratchet ring 21 is rotating. The screws may be screwed in or out therefrom to achieve the effects of disassembly and assembly to firmly fasten (shown as in FIGS. 1 to 8).

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A fastening device for a wrench, used for fastening a barrel or a tool bit, comprising:
a wrench body, having a handle portion and a driving portion, the driving portion is connected with one end of the handle portion, an accommodating groove is arranged in the driving portion, a through hole is passing through a bottom surface of the accommodating groove, an entry slot is concavely arranged at one side wall of the accommodating groove corresponding to the handle portion, and the entry slot is fluidly communicated with the accommodating groove;
a detenting assembly, having a ratchet ring and a detenting teeth block, the ratchet ring is installed in the accommodating groove of the driving portion, a plurality of teeth is arranged at a peripheral of the ratchet ring, a covering hole is formed at a center of the ratchet ring, the detenting teeth block is installed in the entry slot, a teeth bar is arranged at one side of the detenting teeth block corresponding to the teeth of the ratchet ring and the teeth bar and the detenting teeth block are engaged with each other, a pushing portion is arranged at one end of the detenting teeth block opposite to teeth bar; and
an allocating member, inserted into the driving portion and corresponding to the entry slot, the allocating member includes a turning plate and a controlling post, one end of the turning plate is protruded out from the through hole and has a concave arc hole, one end of the controlling post is connected to the turning plate, the other end of the controlling post opposite to the turning plate is inserted into the entry slot, an elastic sleeving member is arranged between the controlling post and the detenting teeth block, and one end of the elastic sleeving member is against the controlling post and the other end thereof is against the pushing portion of the detenting teeth block;
wherein the barrel or the tool bit is quickly separated from the covering hole due to the pivot of the allocating member while the barrel or the tool bit is corresponding to the concave arc hole, and the barrel or the tool bit is firmly fastened in the covering hole to prevent from being separated in operation while the barrel or the tool bit is not corresponding to the concave arc hole.

2. The fastening device as claimed in claim 1, wherein a sharp end is formed at a top end of each side of the concave arc hole of the turning plate, and each sharp end is engaged with the tool bit or the barrel due to the pivot of the turning plate.

3. The fastening device as claimed in claim 2, wherein the elastic sleeving member further includes an elastic member and a reversing block, two ends of the elastic member are respectively against the controlling post and the reversing block, one end of the reversing block opposite to the elastic member is against one end of the detenting teeth block opposite to the teeth bar, and the turning plate is stirred to control a rotating direction of the ratchet ring by the engagement of each sharp end and the tool bit or the barrel.

4. The fastening device as claimed in claim 1, wherein a limiting ring groove is concavely arranged at a wall surface of the accommodating groove of the driving portion adjacent to the through hole, and a C-shaped locking ring is elastically locked in the limiting ring groove so as to limit the ratchet ring.

5. The fastening device as claimed in claim 2, wherein a limiting ring groove is concavely arranged at a wall surface of the accommodating groove of the driving portion adjacent to the through hole, and a C-shaped locking ring is elastically locked in the limiting ring groove so as to limit the ratchet ring.

6. The fastening device as claimed in claim 3, wherein a limiting ring groove is concavely arranged at a wall surface of the accommodating groove of the driving portion adjacent to the through hole, and a C-shaped locking ring is elastically locked in the limiting ring groove so as to limit the ratchet ring.

7. The fastening device as claimed in claim 4, wherein a cap is covered on an opening of the accommodating groove, and the cap is used to limit the separation of the ratchet ring and the detenting assembly.

8. The fastening device as claimed in claim 5, wherein a cap is covered on an opening of the accommodating groove, and the cap is used to limit the separation of the ratchet ring and the detenting assembly.

9. The fastening device as claimed in claim 6, wherein a cap is covered on an opening of the accommodating groove, and the cap is used to limit the separation of the ratchet ring and the detenting assembly.

10. The fastening device as claimed in claim 1, wherein two arc grooves are concavely arranged at the pushing portion and adjacent to each other.
